(19) United States
(12) Patent Application Publication
(10) Pub. No.: US 2026/0070688 A1
(43) Pub. Date: Mar. 12, 2026

(54) NON-UNIFORM LIGHT DENSITY PROJECTOR

(71) Applicants: Itzhak POMERANTZ, Kefar Sava (IL); Yuval KAPELLNER RABINOVITZ, Bat Yam (IL)

(72) Inventors: Itzhak POMERANTZ, Kefar Sava (IL); Yuval KAPELLNER RABINOVITZ, Bat Yam (IL)

(21) Appl. No.: 18/872,058

(22) PCT Filed: Jun. 7, 2023
(86) PCT No.: PCT/IB2023/055850

§ 371 Date: Dec. 5, 2024

Related U.S. Application Data
(60) Provisional application No. 63/349,592, filed on Jun. 7, 2022.

(51) Int. Cl. B64U 50/35; B64U 20/83; B64U 20/87; B64U 50/31; G06Q 20/14

(52) U.S. Cl. CPC B64U 50/35; B64U 20/83; B64U 20/87; B64U 50/31; G06Q 20/145

(57) ABSTRACT

This invention teaches an optical digital projector with non-uniform light density and ways it can be used to remotely charge a target. According to this invention, multiple DOEs fed by multiple laser beams can be used to create multiple rectangles by the optical modulator. In one embodiment of this invention, the FOP can be changed—zoomed in and out and offset in X and Y by moving a projection lens in front of the optical modulator. A camera, pointed at a remote object, is used to close a control loop homing the modified rectangle of light on the remote target.

### FIELD OF INVENTION

The present invention relates generally to a projector, and more particularly to a non-uniform light density projector.

### BACKGROUND OF THE INVENTION

Digital projectors, converting a graphical data file into a projected image are well known in the art (such as KHD38 by Optoma, Taipei, Taiwan). Some of them use a Digital Light Processing (DLP) element that is uniformly illuminated and pixel-wise reflects parts of the light through an optical system onto a target screen.

Projectors are used for graphic displays, television, advertising, Head-up displays, Near-eye displays etc.

These applications do not require that the light density vary across the image, and therefore, prior art projectors do not and cannot offer variable light density at different areas in the image modulator. Moreover—all prior art applications of projectors require the light density to be as uniform as possible across the image, and variations in this parameter are un-desired.

However, there are conceivable applications of digital projectors where non-uniform light density is a blessing, and the uniformity of current projectors is a disadvantage.

Such applications are-remote solar charging of batteries, structured light projection for 3D measurements, smart vehicle headlights and more.

In such applications, where typically a small fraction of the image pixels is active, a lot of light energy is wasted if the light density across the light modulator in uniform.

It would be very desirable to have a projector that can change the light density across the light modulator, and even more so if varying the light density can be programmable.

Unfortunately, such projectors do not exist.

Definition of terms.

DLP—Digital Light Processing (DLP) is a video technology that is used for front and rear projection units.

Light density—the amount of light power projected on a unit area.

DOE—Diffractive Optical Element as defined in the Photonic Encyclopedia https://tinyurl.com/2r9m3yjx.

Field of Projection (FOP)—the spatial angled covered by a projector—the concept is symmetrical with the Field of View (FOV) of cameras that also refers to the spatial angle covered by the camera.

Top-Hat beam shaper—Diffractive optical elements (DOEs) used to transform a near-Gaussian incident laser beam into a uniform-intensity (flat) spot of either round, rectangular, square, line or other shape with sharp edges in a specific work plane.

Spatial Light Modulator—A spatial light modulator (SLM) is an object that imposes some form of spatially varying modulation on a beam of light.

Amplitude SLM—a spatial light modulator that generates an image output by amplitude modulating the incident light.

Phase SLM—a spatial light modulator that generates an image output by phase modulating the incident light.

Active sector—a section inside that represent a portion of the complete field of projection, the field of projection is divided to several zones / sectors.

Cargo—one or more solid objects temporarily carried by a cargo-drone.

Charging traffic load—The number of targets that are being simultaneously charged by a projector at a given time.

ECM—Electronic Counter Measures. Electronic means used by one entity in order to disturb the operation of another entity.

Structured Light—Structured light is the process of projecting a known pattern (often grids or horizontal bars) on to a scene. The way that these deform when striking surfaces allows vision systems to calculate the depth and surface information of the objects in the scene, as used in structured light 3D scanners.

Raw Point Cloud Data—Point cloud data is the term used to refer to the data points collected for a given geographical area, terrain, building or space.

### SUMMARY OF THE INVENTION

The invention teaches the technology and applications of a projector that uses modified adaptive optical elements that modify light density distribution across its light modulator, so that the active parts get high light density and the non-active parts get minimum illumination.

In general, adaptive optical elements are a type of DOR that convert the round, gaussian distribution of a laser beam into a rectangular top-hat distribution that basically covers the whole optical modulator.

The DOE is modified, according to the present invention, so that the rectangular distribution has a variable width and height and can be centered over any position of the optical modulator.

The modification is done by mechanical motion of the DOE and by mechanical motion of one of a couple of additional lenses placed in front of the DOE.

According to this invention, multiple DOEs fed by multiple laser beams can be used to create multiple rectangles on the optical modulator.

In one embodiment of this invention, the FOP can be changed—zoomed in and out and offset in X and Y by moving a projection lens in front of the optical modulator.

In another embodiment of this invention, a camera, pointed at a remote object, is used to close a control loop homing the modified rectangle of light on the remote target.

In another embodiment of this invention, the shape of the beam is determined by a sequence of two optical elements, a beam shaper and a phase SLM: first a top-hat beam shaper converts the gaussian distribution of a laser beam into a rectangle covering the phase SLM. Then, the phase SLM reshapes and positions the beam into a desired light pattern in a desired direction. This replaces the required mechanical positioning of the illumination beam of the previous embodiment. The imaging direction is still mechanical, using a movable front lens that positions and zooms the image.

In another embodiment of the invention, where a projector is used to deliver light energy to a target, un-used light coming from pixels that are in the active sector but are not pointing at the target is recycled and converted back to electrical energy. This embodiment increases the efficiency of battery-operated mobile projectors.

In another embodiment of the invention, a network of projectors is installed in a service area (such as a large city). The projectors are pointing upwards and their FOP's partially overlap. A target, such as a drone, that travels in the service area can be served and charged by the network of projectors almost continuously. If, by way of example, the projectors provide charging energy to the drone (that is equipped with down-facing solar cells), the drone can have a practically infinite flying time and does not need charging stations or huge batteries.

### LIST OF DRAWINGS

FIG. 1 shows a schematic illustration of a network of charging projectors in a service area.

FIG. 2 shows a projection system with a light amplitude modulator.

FIG. 3 shows a schematic illustration of the illumination architecture.

FIG. 4 shows a schematic illustration of the illumination architecture with multiple illuminators.

FIG. 5 shows a schematic illustration of the projection architecture using phase modulators.

FIG. 6 shows a schematic illustration of a projection architecture that recycles light energy from un-used pixels.

FIG. 7 shows a schematic illustration of cargo drone with solar cell panels and on panel reflective id stickers.

### DETAILED DESCRIPTION OF THE DRAWINGS

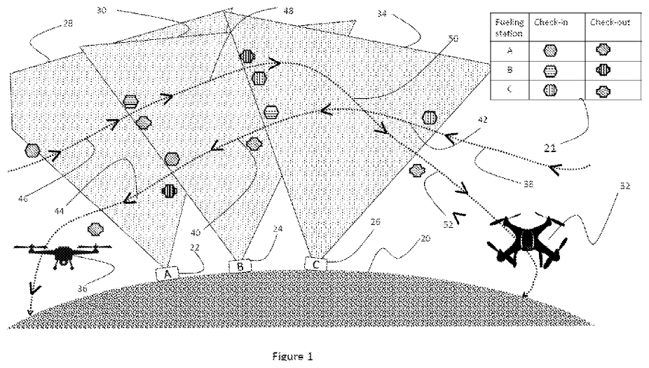

Attention is called to FIG. 1.

A network of three light-charging systems 22 (“A”), 24 (“B”) and 26 (“C”) are projecting light upwards, creating three projection fields 28, 30 and 32.

A drone 32 equipped with down-facing solar cells flies in a course 38 and enters the projection field of station C. it is detected by station C and a communication link between the drone and the station is established. The drone identifies itself and asks to be charged, and the station directs a charging beam of light to the direction of the drone. The drone provides real time feedback to the station, or the station detects the deviation of the drone from the direction of the charging beam, to close a control loop and ensure that the light beam is centered on the drone. This handshaking is considered as a “check-in” action as labeled in the legend table 21. The drone continues to fly on its ordinary course, until it reaches the end of the projection field, then it “checks out” from station C. It is then detected by station B, and is offered charging. If drone 36 wishes to keep being charged, it checks in to station B and flies along course 40 while being charged. When it reaches the end of the field of view, it can check out and immediacy check into station A and continues along course 44, finally when it reaches the end of field of projection of station A, it stops getting charged. Periodically the charging stations can issue a bill to the drones representing the amount of charge, or the duration of charging and be compensated.

The same process happens to drone 32—as it moves along trajectories 46, 48, 50, and 52. The figure shows the check in and check out points of both drones with each station.

A drone can be simultaneously charged by more than one charging station.

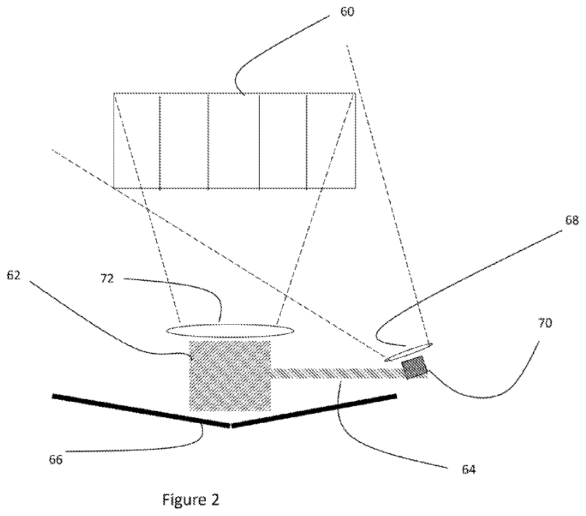

Attention is now called to FIG. 2.

FIG. 2 illustrates DLP architecture in which DLP light engine 62 (such as IR-E4500 MKII-OX by EKB Technologies Ltd, Israel) uses zoomable imaging lens 72 (such as LightCrafter E4710-LC by Texas Instruments, USA) to image the micromirrors array of the DMD modulator. The engine with the lens could be rotated and moved on mechanical axis 66 for rough complete FOP positioning while lens 72 is designed with a stage micro positioning system (such as DLP projection system with configurable lens offset (Y) by ViewSonic PX701HD USA) allowing fine offsetting the image in this case on both axes Y, X. The formed FOP 60 is partitioned digitally allowing allocation specific pixels per region depending on the distance of the target within each region.

Camera 70 (such as DMK 33UX183 by The Imaging Source Germany) is mounted on mechanical holder 64 and is electronically synchronized with the DLP engine 62 which uses trig signals to ensure refresh of both are in sync.

The camera 70 uses zoomable lens 68 to cover a FOV of the projection while its offset on X, Y is modified by motorized stage for fine tuning FOV coverage by its lens positioning in contrast to the camera's sensor as well as by complete rotational movement of the camera around its own mechanical positioning axis on the mechanical holder 64.

In conjunction with the camera, the projected FOP is triangulated with the camera's FOV, using a structured light triangulation procedure such as described in “Multi-Functional Micro Projection Device as Screen Substitute for Low Power Consumption Computing” published by Journal of low power electronics and applications pages 14,15,16 https://www.mdpi.com/2079-9268/2/1/79.

Together, structured light is created, enabling extraction of 3D measurement of the targeted solar cell structure available as raw point cloud data. The produced data enables projecting light to accurately cover the geometry of the solar cell by the projection system for proper charging. Depending on direction and apparent dimensions of the solar cell, the geometric 3D measurement can be superimposed on the physical camera image to create the optimal projection pattern for the projector to cover the target.

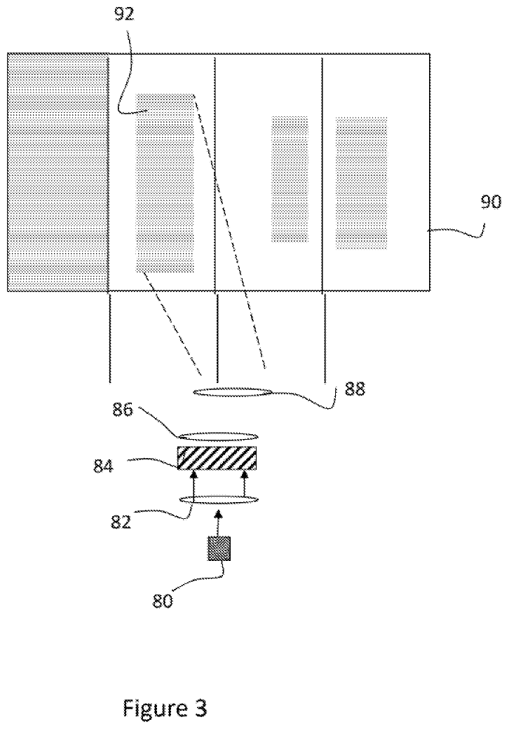

Attention is now called to FIG. 3, which illustrates the illumination architecture of the light engine. Laser emitter 80 (such as DS3-515514-808FN2FN-150.0W by BWT Beijing China) is collimated by collection and collimating lens 82 (such as LTN330-B by Thorlabs, USA) which is then aimed to propagate diffractive optical element (DOE) 84 that serves as TOP-HAT beam shaper. The beam is transformed from Gaussian distribution to a unified Top-Hat formation in the form factor and dimension of the system's light modulator 90. By default, entrance angle to the DOE 84 is of 0 degrees. The DOE 18 is designed to consider externally added Fourier transform which is established by coupling it with a designated lens. This in results provides flexibility regarding dimensions of the illumination pattern by allowing movement of the lens 86. To generate the rectangular Top-Hat pattern Lens 86 is utilized to finalize the beam shaping required. Lens 88 is then incorporated for the purpose of changing the magnification which in result changes the formed rectangular dimension over the DMD modulator 90.

The DMD 90 subdivides its total active matrix resolution into several sectors, and each segment can be illuminated separately. The illumination system enables changing the density of light across the DMD 90 mirror array at different sectors across it, accounting for target's distance and direction. To target only specific sectors in the DMD 90, the DOE 84 is designed to be mechanically rotated around its own positioning axis to enable 0 to 45 degrees laser propagation. The laser source is mounted on a motorized stage that can change the incident angle into DOE 84 by modifying its position in relation to the propagating input beam. As a result, DOE 84 setting generates astigmatic beam shaped illumination which delivers a varying beam shape coverage size across the modulator 90. The beam shape depends on the rotational position where it could be configured to cover to illuminate a smaller segment as shown, by way of example, across partitioned area 92 presenting a specific sector sector of DMD 90 being illuminated.

As an example: spot 92 covers a portion of the DMD 90 when the DOE 84 is configured to be parallel to the propagating light being at 0-degree position in comparison to when light propagates it at 45 degrees where the result would then be small rectangular spot coverage across DMD 90 (vs. 45 degrees positioning case where the entire DMD 90 will then be illuminated).

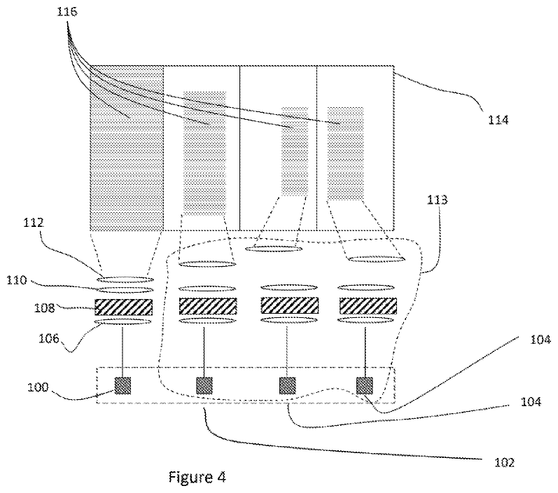

Attention is now called to FIG. 4 that schematically illustrate the illumination architecture with multiple illuminators.

Block 100 represents an example of multiple of laser emitters. in this example there are 4 emitters, each corresponds to its own singular illumination channels referring to channels 102,104,106 as shown in the drawing. The emitters enable changing illumination sectors 118 with respect to the target coverage necessary without compromising light density, thus delivering sufficient energy to the target.

Laser emitter 100 generate a Gaussian laser illumination which is then collected by collection and collimating lenses (such as LTN330-B by Thorlabs, USA) An example description is here provided for single channel to describe all channels. Lens 108 is shown to serve as a collection and collimating lens (in the drawing, the left example represents one out of the 4 channels while each consists of the same type of projection route and calibration options at different matrix sectors across the DMD).

The collimated beam off lens 108 propagates a DOE 110 which reshapes the Gaussian distribution and converts it to rectangular top hat formation with respect to the physical dimension of DMD modulator 116. DOE 110 is installed on a motorized stage that enables modifying its position in relation to the propagating laser source thus enables forcing desired state of optical astigmatism when needed which affects the generated beam dimension that is spread across DMD 116. (Beam cross section can shrink or stretch, depending on the setting at a given time).

Optical elements 113 are identical to the corresponding elements 112-100 projecting additional rectangles on the modulator, for covering additional targets.

The common design of DOE 100 is made to accommodate an external lens. The external lens in the present embodiment 110 is designed to shape the DOE beam so that a second lens 112 can determine, by its position and orientation, the shape and position of the illumination rectangle on the target. 113 shows additional beams, with different orientations of lens 112, illuminating different rectangles within the POV 114 on the target.

Lens 114 position is controlled by motorized stage that enables its movement across Z axis as well as Y and X.

In this embodiment, the described control of the DOE 110 with lens 112 enable coverage shifting across given DMD 116 partitioned sector 118 (as shown) without compromising energy level.

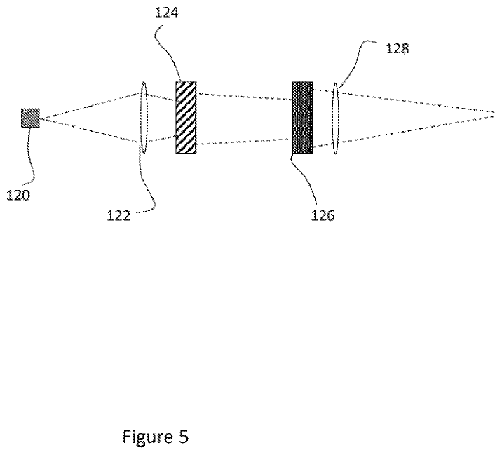

Attention is now called to FIG. 5, which schematically illustrates projection architecture that uses DMD phase modulator rather than DMD amplitude modulator type.

Laser emitter 120 is collected and collimated by lens 122 (such as LTN330-B by Thorlabs Inc USA) and is then converted to rectangular top hat illumination pattern by beam shaper 114 (such as ST-212-I-Y-A by Holo-Or Ltd ISRAEL). The produced new spot is a conjugated rectangular top hat spot that is then utilized to illuminate phase modulator DMD 126 designed to be paired with lens 128 to resolve a programmed pattern. Lens 128 is located on an X, Y stage, (such as LPS710E by Thorlabs Inc, USA) that enables fine FOV offset adjustment.

The phase DMD 126 enables producing patterns by means of diffraction. It minimizes loss of energy while allocating most of the propagating energy in the predetermined reformed programmed pattern making it highly efficient modulation approach.

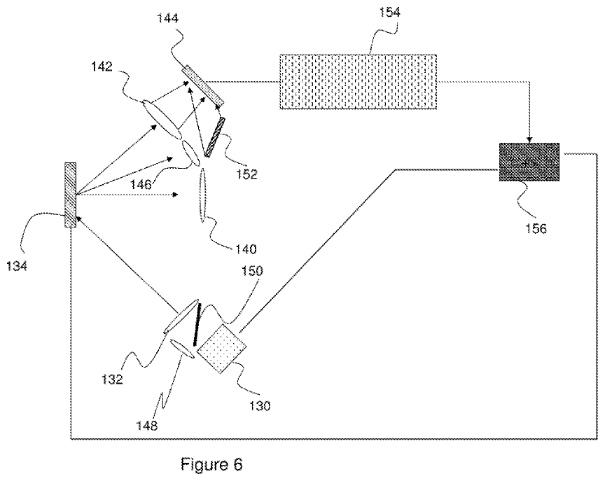

Attention is now called to FIG. 6 that illustrates DLP architecture in which both images that are produced by the DMD are utilized.

the first image is utilized for the purpose of imaging and data projection while the other image is utilized for the purpose of Illuminating a solar cell or any variant of solar cell such as high efficiency multi layered cell sandwich of high density type (such as CTJ30 by CESI ITALY) for the purpose of producing an energy feedback loop for energy conversion.

Light source 130 is, by way of non-limiting example, for side illuminating the DMD 134 where's optics 132 is used for light collection and could be also used for light shaping for proper DMD 134 illumination coverage.

DMD 134 produces pattern which is designated for data projection and is imaged by lens system 140.

In the above process, the DMD mirror array would naturally produce a negative image which is then deflected to lens 142 which is designed to collect it and produce a conjugated beam across energy harvesting solar cell 144.

It should be noted that lens 142 could also include means of special beam shaping optics to enable light reshaping for the purpose of producing even illumination across the solar cell 144.

When the DMD 134 is in park position (that is hereunder called “flat light state”. Modulation state is +12 deg or −12 deg. Park position is flat state 0 degree), a second lens 146 is utilized in the presented architecture example for the purpose of collecting park position illumination in case existed by any light propagating the DMD 134 without modulation present.

The described architecture is used for harvesting power. While the system is off a 45 degree high-transmission mirror and mechanical switch 150 enables, when flipped from 0 deg to 45, to collect external ambient light through collection optics 148. In conjunction with lens 132, mirror 150 enables a full illumination path to the DMD 134 and since all the pixels of the DMD are in flat position, the DMD behaves like a flat planar mirror, and enables rays to bounce off it and be collected through lens 146.

The rays are then deflected by a side mirror 152 to effectively illuminate solar cell 144 and convert the light back to reusable electric energy.

It should be noted that the description above shows an exoplanar configuration, and this effect can be produced by other optical architectures to achieve the same.

Solar cell 144 {such as flex—Flexible CIGS Solar PV by Flisom, Switzerland) converts the optical power to electrical power which is then handled by hardware circuitry 154 to properly harvest the radiated electrical energy and then charge battery 156 which is also used to feed the complete system and is connected to light source 130 and DMD 134.

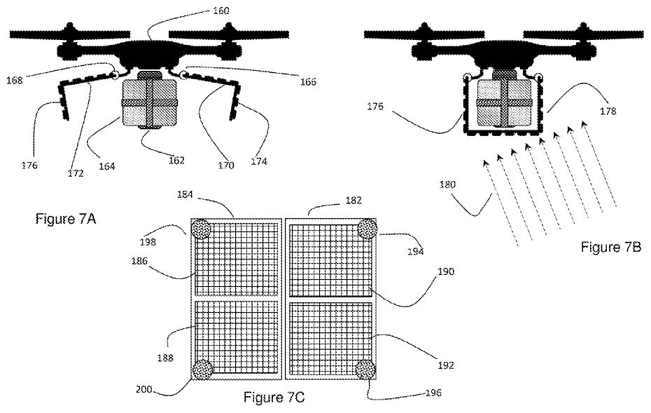

FIG. 7 schematically illustrates an architecture in which solar cell is integrated as part of a mechanical packaging mount on a cargo drone to enable easy access by remote charging station of the drone for charging on the fly.

FIG. 7A shows a drone 160 comprising a motorized mechanical arm 162 designed to grip and hold a cargo 164 while flying and release it upon landing.

Movable arms 170, 172 are covered by solar cells there are solar cell panels 174, 176 installed on their outer side and bottom. An attached cargo 162 as shown can be released or picked up depending on arms position to allow latching and locking in place or releasing the cargo.

FIG. 7B illustrates the cargo a state where the arms are latched to secure the cargo for shipment.

In the latched position the solar cells located on the arms all across 178 and 176 are exposed to a propagating light 180 coming from the ground from the remote charger to illuminate them for the purpose of charging the drone on the fly.

FIG. 7C. illustrates the bottom view of the latching mounts 182,184 that are part of the mechanical arms. The solar cells 186, 188, 190, 192 are exposed outwards to accommodate charging from the ground. Retroreflective ID stickers 194, 196, 198, 200 are used to enhance the detection of the drone by the charging station and provide error signals for positioning the beam towards the position of the drone to the charging projection station: if the reflection from all 4 stickers is uniform, the beam is centered on the drone. Any deviation from this direction will vary the intensity of reflection from the 4 stickers and provide an error signal for correction. Alternatively, if the charge harvested by the four solar panels 186, 188, 190, 192 is uniform, the beam is centered on the drone. Any deviation from that direction will create a difference in power between the panels, and will create an error signal sensed by the drone and communicated to the station.

1. A digital projector comprising at least one DOE and at least one DLP, the DOE configured to illuminate the DLP non-uniformly according to a predetermined pattern.

2. A projector as in claim 1, configured to modify the illumination of the DOE on the DLP using mechanical movement of at least one of the DOE and a front lens.

3. A projector as in claim 1, comprising at least two DOE's, each of which is independently configured to illuminate parts of the DLP.

4. A projector as in claim 2 configured to track and illuminate a moving target

5. A system as in claim 4 where the projected image is configured to charge a target that comprises at least one solar cell.

6. A system as in claim 9 where the projected image is configured to blind a camera mounted on the target.

7. A projector as in claim 2 where the DLP is an amplitude modulator

8. A projector as in claim 2 where the DLP is a phase modulator

9. A projector as in claim 4, wherein the projected image is a light beam less than 3 spatial degrees wide.

10. A remote charging system comprising a projector as in claim 9 comprising a communication link between a charged object and the projector.

11. A system as in claim 10 wherein the communication system is secure.

12. A system as in claim 10 comprising feedback from the charged object to the projector indicating the offset between the direction of the charging beam and the position of the charged object.

13. A system as in claim 10 wherein the charged object is a drone.

14. A system as in claim 9 wherein the target comprises at least one retroreflective surface exposed to the projector

15. A system as in claim 14 wherein the difference of the intensity of reflection from at least two separated retroreflective surfaces is used as an error signal in a closed loop control.

16. An system as in claim 12 wherein the difference in received light power between at least two separated solar cells provide an error signal for a closed loop control.

17. A drone as in claim 13 comprising solar cells configured to absorb light energy coming from below the drone.

18. A drone as in claim 17 comprising a first and a second position of the solar cells, wherein in the first position the drone can load and off-load cargo, and in the second position the solar cells are exposed to light energy coming from below the drone.

19. A system as in claim 13 wherein the drone carries a camera, and the charging light frequency is filtered out of the camera.

20. A system as in claim 10 wherein the drone comprises a camera and the system comprises time division between the camera acquisition time and the charging time.

21. A system as in claim 11 comprising a billing system that bills the drone according to at least one of charging time, delivered charge, number of charging sessions and charging traffic load.

22. A system as in claim 6 wherein the projected light varies randomly as a means of ECM against cameras.
